(19) United States
(12) Patent Application Publication
(10) Pub. No.: US 2007/0043645 A1
(43) Pub. Date: Feb. 22, 2007

(54) Structuring method and associated modelling software for the syndication of federal low-income housing tax credits generated by mixed-income tax-exempt bond financed low-income housing tax credit projects

(76) Inventors: Daniel Wiehler, New York, NY (US); Christopher Michael Cotter, Nanuet, NY (US); Glenn Steven Miller, McLean, VA (US)

Correspondence Address: BINGHAM MCCUTCHEN LLP, 3000 K STREET, NW, BOX IP, WASHINGTON, DC, 20007, US

(21) Appl. No.: 11/204,109

(22) Filed: Aug. 16, 2005

(51) Int. Cl. G06Q 40/00

(52) U.S. Cl. 705/36 T

(57) ABSTRACT

Mixed-income housing projects generate federal low-income housing tax credits. Previously, due to numerous impediments, it has been impossible to efficiently syndicate these credits, resulting in many going to waste every year. The present invention relates a method that allows for more efficient syndication of the available tax credits, as well as provides more efficient means for analyzing the potential syndicatability of the tax credits generated by a given building project.

### FIELD OF THE INVENTION

The present invention relates generally to a method of assessing, structuring, and documenting complex financial transactions. In particular, it relates to assessing, structuring, and documenting the sale (“syndication”) of low-income housing tax credits under section 42 of the Internal Revenue Code (“credits”), generated by tax-exempt bond financed projects a portion of the renters of which are subject to income restrictions (known as “mixed-income projects”), as well as the use of associated computer software to model such a structure. The method provides for a more efficient structure for acquisition and utilization of credits generated by mixed-income projects. The software mathematically models the working of such a structure and optimizes the structure.

### BACKGROUND OF THE INVENTION

The Low-Income Housing Tax Credit program (LIHTC), created as part of the Tax Reform Act of 1986, is one of the federal government's most important tools for the development of affordable rental housing. Third party equity investors (“credit investors”) receive credits over a 10-year period against federal taxes owed in return for providing funds to developers to help build or renovate housing for low-income families. This capital subsidy allows rents to be set below the cost of developing and maintaining the property. The LIHTC gives credit investors who would otherwise never invest in affordable housing an economic incentive to do so.

A mixed-income housing project is a specific type of housing project wherein a percentage of the dwellings are occupied by persons of low income. Often the low-income dwellings are offered at a rate less than the market rate, while the remaining dwellings in the project are offered at market rate. Additionally, the minimum percentage of low-income dwellings is often specified for a project to qualify as a mixed-income housing project. For example, in New York City in a mixed-income housing project, usually 20% of the dwellings are low-income, while the remaining 80% are market rate. So-called “80-20 projects” are one type of mixed-income housing project.

Because the low-income dwellings in a mixed-income housing project qualify as low-income housing, they qualify for credits. The amount of credits awarded to a mixed-income project is primarily based upon the amount of development costs and the number of low-income units in the mixed-income project. Generally, for a mixed-income project to be eligible for credits, at least 20 percent of its units must be set aside for households with incomes of less than 50 percent of the area median. Most low-income housing tax credit developments typically have 100 percent low-income units, therefore garnering the highest amount of credits possible for a development and avoiding the many impediments and risks involved with mixed-income projects (those that consist of both market-rate units and low-income units). There are, however, certain benefits to mixed-income projects. Some state tax credit agencies have elected to give preferences and real estate tax abatements to mixed-income projects. Moreover, because general economic principles influence where tax-credit-subsidized low-income housing will be built, rental income from market-rate units make the economics for mixed-income projects more feasible, especially in major cities. Economically-defined parameters make it more difficult to build LIHTC housing in major cities because land costs are higher and low-income rents are substantially below market rate rents. Efficiently syndicating the credits of mixed-income projects would generate additional equity contributions for mixed-income projects and help to alleviate these economic impediments to mixed-income projects, thereby promoting important housing goals by creating additional affordable housing.

Credit investors historically have been reluctant to “purchase” credits in syndication transactions from mixed-income projects, which is the primary type of low-income development in major cities, such as New York City. There are four key impediments to credit investor investments in mixed-income projects that have made it essentially impossible to syndicate credits from mixed-income projects. These are referred to as the Depreciation Impediment, the Cash Leakage Impediment, the Transfer Tax Impediment and the Recapture Impediment.

The Depreciation Impediment

Because credits track the depreciation deductions resulting from the mixed-income projects, the credit investor must be allocated depreciation deductions from the mixed-income project in order to claim the credits. However, these depreciation tax deductions that were required to be allocated to credit investors in mixed-income projects had the effect of depressing the financial accounting income of the public-company credit investors (the primary type of credit investors), thus decreasing their market capitalization and making such investments unattractive (the “Depreciation Impediment”). Historically, credits from mixed-income projects do not adequately compensate publicly traded corporate credit investors for the adverse impact on financial accounting income caused by the allocation of depreciation deductions from these investments (the deprecation to credit allocation ratio is typically 13 times greater than a similar investment in a 100% low-income development). An additional risk arises from the high ratio of depreciation allocated to credit investors in relation to the investment made by credit investors. The large amounts of depreciation allocated to credit investors typically will cause the credit investors' capital accounts to go prematurely negative and cause deprecation and credit allocations to be inadvertently reallocated to developers instead of the credit investors who “purchased” the credits.

A largely unsuccessful attempt was made to address the Depreciation Impediment through the recent development by the marketplace of so-called condominium structures in which the low-income units and the market-rate units in a mixed-income project are separated into two condominium units, and only the depreciation deductions from the low-income units are allocated to the credit investors. These condominium structures had the theoretical effect of limiting the percentage of the depreciation absorbed by the credit investors to approximately the percentage of low-income units (as low as approximately 20% of the residential units) of the total depreciation deductions generated by the mixed-income project. Unfortunately, establishing condominium regimes for mixed-income projects often cause additional problems, including the need to obtain no-action letters from certain states' attorneys general and the overall time and administrative expense necessary to create the condominium units. In addition, the condominium structures failed to address certain additional federal income impediments which, as discussed below, effectively prevented the use of such structures.

Cash Leakage Impediment

As a result of industry interpretations of certain United States Internal Revenue Service (“IRS”) rules, credit investors have been required to participate in the income and cash flow of the market-rate units of mixed-income projects in order to receive credits. This made selling the credits less attractive to developers who placed a higher value on the cash flow than did the credit investors. This is referred to as the “Cash Leakage Impediment”. Shortly after the creation of the condominium structures discussed above, syndicators encountered resistance from the bond lawyers of the major housing credit agencies. Developers had attempted to utilize the partnership tax rules to specially allocate 99.9% of the depreciation deductions generated by the low-income unit condominium to the credit investors and 99.9% of the depreciation deductions generated by the market-rate unit condominium to the mixed-income project developers (“99.9% Condominium Structure”) in order to minimize the Cash Leakage Impediment. The bond lawyers unanimously refused to issue bond opinions to the agencies issuing the bonds financing the mixed-income projects, however, arguing that there was a significant risk that the IRS would “bifurcate” the mixed-income project partnership into two partnerships for federal income tax purposes (one partnership holding the market-rate condominium and one partnership holding the low-income condominium). Such a bifurcation, it was believed, would violate certain tax rules requiring that bonds that finance mixed-income projects containing “multiple buildings” (such as multiple condominiums) be held by a single taxpayer to be considered a qualifying “residential rental project” that is eligible for tax-exempt bond financing. Accordingly, the bond lawyers refused to issue tax opinions that the bonds were tax-exempt under a 99.9% Condominium Structure.

In response, syndication lawyers in the marketplace unsuccessfully attempted to utilize a modified condominium structure in which up to 90% of the depreciation deductions and credits derived from the low-income condominiums (as opposed to 99.9%) and as low as 10% of the income and cash flow from the overall mixed-income projects were allocated to the credit investors (the “90-10 Condominium Structure”). Although ultimately approved by the bond lawyers, the obvious drawback of this structure is that 10% of the credits could not be syndicated to credit investors but instead were required to be allocated to the developers of the mixed-income projects where they typically were never used due to various restrictions on the use of credits by individuals (as opposed to corporate credit investors). In addition, credit investors were typically unwilling to pay market-price for the cash flow generated by the mixed-income project (10% of which was allocated to them under the 90-10 Condominium Structure) and typically discounted the value of the cash flow heavily. This factor made syndicating credits from mixed-income projects using the 90-10 Condominium Structure unattractive for developers, which valued the potential cash flow from mixed-income projects more highly than the credit investors.

The Transfer Tax Impediment

Third, credit investors who buy into traditional structured partnerships holding preexisting buildings where the bulk of the credits go to one partner and the bulk of the income goes to another could be faced with a disproportionately large state and local transfer tax calculated as though they purchased the low-income portion of the mixed-income project (including any debt encumbering the mixed-income project) for cash even if they pay a much smaller amount for the associated credits. This is referred to as the “Transfer Tax Impediment”. This results from the fact that the credit investors are deemed for transfer tax purposes to assume the debt encumbering the mixed-income project, which tends to inflate the deemed purchase price for transfer tax purposes.

The Recapture Impediment

Fourth, potential credit investors in mixed-income projects have been unwilling to assume the real estate risk associated with the market rate units in the mixed-income project, referred to as the “Recapture Impediment.” The Recapture Impediment arises because any default on the mixed-income project mortgage resulting from the economic failure of the market-rate units and the ensuing foreclosure of the mixed-income project results in a termination of the flow of credits (if foreclosure occurs during the first 10 years) and the recapture of a portion of the credits from mixed-income projects previously claimed by the credit investor (if foreclosure occurs during the first 15 years (the “LIHTC Compliance Period”)). In contrast to a mixed-income project, 100% low-income occupancy developments have little or no recapture risk. This is because 100% low-income occupancy developments typically include substantial portions of soft debt or equity that are deeply subordinated and that possess maturity dates occurring after the end of the 15-year LIHTC Compliance Period. This reduces the likelihood of a default on the debt during the LIHTC Compliance Period and concurrently reduces the likelihood of recapture of the credits. At the same time, there is the general assumption that 100% low-income occupancy developments will generally stay fully rented because of the attractive rents offered. Mixed-income projects, on the other hand, have significant current debt service obligations that are dependent on the success or failure of the market-rate units in the mixed-income project which must compete for tenants with a greater number of alternatives and are subject to the fluctuations of unregulated market rents. If the market-rate units cannot support the debt service of the mixed-income project, foreclosure on both the market-rate and low-income units could occur, resulting in the termination of and the recapture of the credits, as discussed above. As a result, there is a perception that there is a greater risk of default on the bonds, foreclosure of the properties and elimination and recapture of credits in the case of mixed-income projects.

These four historical impediments to the successful syndication of credits from mixed-income projects have effectively prevented the development of an efficient market for these credits. The market for LIHTC, which generally pays 90-95 cents for each dollar of allocated credits related to 100% low-income developments, is nonexistent in the case of mixed-income transactions and any isolated transactions that do occur heavily discount the price of the credits.

Accordingly, there is a need for a method of structuring mixed-income projects that eliminates the material risks and impediments associated with mixed-income projects. There is a further need to provide an efficient structure for the development of new mixed-income projects, as well as an effective means of utilizing credits from mixed-income projects.

### SUMMARY OF THE INVENTION

According to one embodiment of the invention, a method is provided to assess and effect the transfer of federal low-income housing tax credits generated by mixed-income housing tax credit projects to a qualified recipient. The method includes identifying a mixed-income housing project with tax credits available for syndication and determining a partnership structure with one or more partnerships for effecting the syndication of the tax credits. Then, various enforceable agreements are documented, including transferring value from a credit investor to a partnership in exchange for at least a portion of the tax credits, establishing the determined partnership structure, and, in the case of a two-partnership structure, transferring for tax purposes the ownership of the low-income units in the project to the partnerships in which the credit investor is a partner. These agreements are at least partially carried out.

At least one of the partnerships may be a syndication entity, and at least one of the agreements may document an exchange of at least a portion of the value and ownership for tax purposes of the low-income units to the syndication entity. Additionally, at least one of the partnerships may be a project entity, and at least one of the agreements may document a transfer of at least a portion of the tax credits and ownership of the low-income units for tax purposes to a second partnership.

The method may further include collecting information related to the project and calculating the effects of this information upon the related economics, such as the cash flow, profits, capital gains, and depreciation of the project. These calculations may be used to optimize the agreements, including maximizing the available syndicatable tax credits. Further, these calculations may be performed by a computer program.

The method may also include steps for mitigating the risk of recapture or termination of the tax credits in the event of economic failure of the project. These steps may take a variety of forms, such as a Subordination, Nondisturbance and Attornment Agreement (“SNDA”) obtained from the lender or credit enhancer of the project, a financial guaranty that the tax credits will not be recaptured, or the placement of the value transferred from the credit investor into an interest-bearing escrow to be paid out to the syndication entity over a period of time, for example, 15 years.

A SNDA may be preferable to the other options. If a SNDA is not available, a financial guaranty may be the next most preferable, and the use of an escrow may be the least preferable of the recapture mitigation techniques.

The specifics of these mitigation techniques may be influenced by the aforementioned economic factors, and may include a cost based upon calculations involving said factors. These calculations may be carried out by a computer.

In another embodiment of the present invention, is provided to assess and effect the transfer of federal low-income housing tax credits generated by mixed-income housing tax credit projects to a qualified recipient. The method includes identifying a mixed-income housing project with tax credits available for syndication, identifying economic factors that affect the syndicatability of the tax credits, modeling the effects of the value-based economic factors upon the syndication of the tax credits, and determining a partnership structure with one or more partnerships partnership for effecting the syndication of the tax credits in terms of the modeled economic factors. Then, various enforceable agreements are documented, including transferring value from a credit investor to a partnership in exchange for at least a portion of the tax credits, establishing the determined partnership structure, and, in the case of a two-partnership structure, transferring for tax purposes the ownership of the low-income units in the project to the partnerships in which the credit investor is a partner. These agreements are at least partially carried out.

In all other ways, this embodiment is identical to the first embodiment.

In another embodiment of the present invention, a computer software program is provided that serves to perform calculations related to the syndication of federal low-income housing tax credits generated by mixed-income housing tax credit projects. The compute program generates output related to economic factors that may affect the syndicatability of the tax credits, the structure of the potential partnerships, or the form of documents and agreements involved in the syndication of the tax credits. These economic factors may include cash flow, profits, capital gains, and depreciation of the project. Further, these calculations may be used to optimize the partnership structuring agreement, including maximizing available syndicatable tax credits.

The program's input variables may relate to either the project or the syndication of the tax credits associated with the project. Examples of such variables include development information, tax credit information, debt parameters, fair market value information, tax depreciation information, information relating to the amortization of deferred costs, and cash flow projections. Additionally, the program may allow a user to provide input regarding a desired partnership structure for effecting the syndication of the tax credits.

From these inputs, the program may be able to generate models based upon the gathered information. For example, these models may take the form of charts, graphs, or tables. These representations may convey information about, for example, investor capital accounts, developer capital accounts, benefits to developers, 15-year projections of the net operating income, taxable income, and net cash flow, investor tax credit valuation, investor cash valuation, and summaries of investor valuation.

Another embodiment of the present invention provides a method for assessing the transfer of federal low-income housing tax credits generated by mixed-income housing tax credit projects to a qualified recipient. The method presented in this embodiment serves to gather information related to a building project and determine the capability for syndication of any tax credits that may be available. First, any economic and predetermined structural factors that may effect the syndicatability of the tax credits are determined, as well as a desired partnership structure with at least one partnership, and assumptions related to those involved in the project or the syndication of the tax credits. If the project is determined to be feasible, economic projections resulting from the economic factors and the desired partnership structures may be calculated. These economic factors may include cash flow, profits, capital gains, and depreciation of the project.

Structural factors that may affect the syndicatability of the tax credits include, for example, whether the project is a single- or multi-building project, and whether the building is a new project or one that is already in service. The desired partnership structure may be partially based upon this information, and may be influenced by other factors. These factors may include, for example, the desirability of a two-partnership structure and the availability of a technique for mitigating the risk of recapture or termination of the tax credits. The techniques for mitigating the risk of recapture or termination of the tax credits may be the same as those already mentioned.

Based upon this information, the structure of the partnerships, as well as the agreements among them may be determined by selecting from among predetermined structural alternatives. These alternatives may be related to basic legal structure, type of project, method of payment, tax basis depreciation method, depreciation value, profit and loss allocation, net cash flow distribution, residual cash distribution, presence of a guarantee fee, presence of a collar, presence of an incentive management fee, debt allocation, investor exit strategy, and separation of residential from commercial. Economic factors related to the assessment of the project may determined based on information related to project development, tax credits, debt parameters, fair market value, tax depreciation, amortization of deferred costs, and cash flow projection. Additionally, these factors may include assumptions related to a syndicator and a credit investor.

This information may be collected and used to generate models, which may in turn be based upon the economic factors, the predetermined structural factors, or the desired partnership structure. These models may take the form of, for example, charts, tables, or graphs.

In another embodiment of the present invention, a method for syndicating credits from mixed-income projects solves the historic and economic problems associated with single-building mixed-income projects. In particular, the issues associated with the Depreciation Impediment, Transfer Tax Impediment and Cash Leakage Impediment are minimized or eliminated, and an efficient means of syndicating the maximum amount of credits (up to 99.9%) is created. Moreover, the present invention provides several alternatives for eliminating the risks associated with the Recapture Impediment, thereby permitting the creation for the first time of an efficient marketplace for the syndication of credits from mixed-income projects. The IRS has recently issued private guidance in response to a request filed by one of the patent applicants in the form of a confidential (and currently unpublished) IRS private letter ruling (the “Private Letter Ruling”) that has the potential to greatly increase the marketability of credits from mixed-income projects by permitting the creation of this new structure that effectively eliminates the abovementioned impediments.

A software program may be used to analyze the economics of a mixed-income project, including, for example, the number of (and floor space attributable to the) low-income units, the number of (and floor space attributable to the) market-rate units, the projected market-rate unit and low-income unit rental income stream, the estimated income tax basis of the mixed-income project, the expected debt service of the mixed-income project and various other variables (See FIG. 2). The program would specify an optimal structure for the syndication of a particular mixed-income project as well as the terms of the documents to be drafted, as discussed below.

Once a computer analysis has been completed, and the subject mixed-income project has been determined to be capable of being syndicated, the business process described in FIG. 7 would be applied to determine as a preliminary matter whether one or two partnerships should be employed. If the mixed-income project consists of multiple buildings or if specific developer or credit investor preferences for utilizing a single partnership are expressed, a single partnership will be employed to own the mixed-income project and the credit investor will invest in the single partnership. If a single partnership is utilized, the low-income units and market-rate units will be organized into separate condominiums, for example a 90-10 condominium structure (in the case of multiple buildings), or a 99.9% condominium structure (in the case of a single building).

On the other hand, if the mixed-income project involves a single building (such as a high-rise building as is common in larger cities in which many mixed-income projects are located) and the developer and credit investor so desire, two partnerships would be created. One partnership (the “Project Company”) would hold the fee interest in the mixed-income project and the other partnership (the “syndication company”) would lease the low-income units in the mixed-income project from the Project Company pursuant to a long-term lease that would be treated as a sale for federal income tax purposes. The lease would be subordinated to mortgages placed on the project company, but the syndication company would not be subject to the Project Company mortgage. In the alternative (and depending on the analysis produced by the computer software), two condominiums could be created, one consisting of all the market-rate units (the “market-rate condominium”) and one consisting of all the low-income units (the “low-income condominium”), and the condominium consisting of the low-income units could be sold or otherwise assigned to the syndication company.

Depending upon local law, an alternative to the creation of separate condominiums is to transfer the low-income units to a separate single-member limited liability company that is treated as a disregarded entity for federal income tax purposes. Both the creation of a condominium and the use of a single-member limited liability company typically result in the creation of a separate property interest for local real estate law purposes. For simplicity, both an actual condominium consisting of low-income units and a single-member limited liability company holding low-income units are referred to herein as a “low-income condominium.”

In the case of a mixed-income project that has already received a building identification number (“BIN”) by the agency prior to syndicating the credit to a credit investor, it will be necessary under existing IRS rules to organize the low-income units and market-rate units into separate condominiums prior to entering into the lease. Condominiums are not necessary where the mixed-income project is syndicated and the lease entered into prior to the receipt of a BIN and prior to the project being placed in service

Subsequently, a credit investor would contribute cash to the syndication company (in an amount determined by the computer software) in exchange for membership interests entitling the credit investor up to a 99.9% share of the profits, losses and depreciation deductions of the syndication company as well as up to 99.9% of the credits. The general partner/managing member of the syndication company (the “syndication general partner”) would retain a percentage interest, for example 99.9%, in any capital gains resulting from the syndication company. Currently, 99.9% allocations are the maximum permissible under IRS rules, but lower allocations (e.g., 99%, 98%, 97% etc.) are permissible and anticipated by the Capital Lease Structure.

As discussed above, it was previously not possible prior to the present invention to allocate more than 90% of the credits to credit investors because of the significant risk that the split-ownership of the mixed-income project would violate the tax-exempt bond financing “residential rental project” rules, thereby preventing the issuance of bond opinions to the housing agencies. This risk is eliminated by the combination of the Private Letter Ruling, which confirms that a single building (such as a high-rise skyscraper apartment building) can qualify as a residential rental project regardless of the number of owners, and the innovative use of a separate partnership to hold the low-income units (in the case of the two-partnership variation). Because the present invention is inexpensive to develop and administer, the present invention is a more economical and efficient alternative to the existing 90-10 Condominium Structure, which involves considerable costs and administrative hurdles relating to the creation of separate condominiums and only allows the syndication of 90% of the credits.

Finally, because the leases according to the present invention are not subject to the overall mortgage debt of the mixed-income project, the credit investment does not trigger transfer taxes in a number of jurisdictions, thereby helping to minimize the Transfer Tax Impediment.

Methods according to the present invention may be accomplished as follows. First, a project is analyzed, for example with a computer, to determine whether the credits are capable of being syndicated, which alternatives would be optimal to syndicate the credits, and the appropriate inputs to the creation of documents to establish the syndication.

Second, the syndication company is organized and a commitment is received from the credit investor to invest a certain amount of cash in the syndication company, which may be determined by the software (the “Syndication Investment”). The Syndication Investment is contributed to the syndication company.

Third, the syndication company operating agreement may be executed by the credit investor and the syndication general partner and allocates a percentage, for example 99.9%, of profits, losses, depreciation, cash flow and credits to the credit investor and the remaining percentage to the syndication general partner.

Fourth, prior to the credits becoming “allowed” (i.e., prior to the issuance of a BIN on the mixed-income project) and prior to the project being placed in service, the lease (the economic terms of which may be determined by a computer program) is entered into between the Project Company and the syndication company, leasing the low-income units to the syndication company. The lease provides for an up-front payment which may be equal to the amount of the syndication investment (the “up-front payment”), as well as monthly payments that may, for example, approximate, on a present-value basis (when coupled with the up-front payment), the tax basis of the low-income units (“monthly payments”). The lease will be considered a sale of the low-income units for federal income tax purposes and the monthly payments will be considered payments of interest and principal on a deemed loan from the Project Company to the syndication company. Any amount of the monthly payment that is unable to be paid currently by the syndication company out of cash flow would be deferred and would accrue interest at a market rate and would become fully payable by the syndication company after, for example, year 15 of the term of the lease. In the alternative, the low-income units and the market-rate units can be organized into two separate condominiums and the low-income condominium either leased pursuant to a similar long-term lease (treated as a sale for federal income tax purposes) as described above, or sold to the syndication company.

Fifth, once the BIN is issued, the credits become “allowed” to the syndication company and the eligible basis of the low-income units is equal to the purchase basis of the low-income units (as determined by the Lease). The credits may be then allocated to and claimed by the credit investor over a period of time, for example the next 10 years.

In the case of an existing mixed-income project in which the BIN has already been issued (as opposed to a newly constructed or yet-to-be constructed mixed-income project which has not yet been issued a BIN and has not yet been placed in service), a portion of the credits would have previously been claimed by the project company. In such case, the low-income units and market rate units would first be organized into low-income condominiums and market-rate condominiums. The low-income condominium would then be transferred to the syndication company pursuant to a long-term lease (or a sale to the syndication company of the low-income condominium, as applicable) and the syndication company would claim the remaining portion of the credits not previously claimed by the Project Company.

Sixth, (if possible) the syndication company obtains, for example, a Subordination, Nondisturbance and Attornment Agreement (“SNDA”) from the credit enhancer of the mortgage on the mixed-income project that would avoid any risk of recapture or termination of the credits even in the unlikely event of a foreclosure on the market rate units. The credit enhancer, in exchange for a fee, may agree to enter into an SNDA with the syndication company, thereby subordinating the mortgage to the long-term lease and providing that in the event of a foreclosure, the credit enhancer will honor the syndication company's lease. The SNDA preserves the low-income nature of the syndication company and ensures that the credits will not be recaptured as long as the syndication company continues to make payments on the long-term lease. The credit enhancer is permitted, pursuant to the terms of the SNDA, to replace the syndication general partner in the event of a default on the mortgage.

As alternatives to the SNDA agreement discussed above, the present invention, allows for several different options that serve to eliminate the risk of recapture in the event a particular lender is not willing to provide a SNDA. First, the credit investor can arrange for a financial guarantee from the Project Company that the credits will not be recaptured, essentially eliminating the Recapture Impediment. Second, the syndication investment can be placed in an interest-bearing escrow to be paid out to the syndication company over a period of years (for example, up to 15 years) as the recapture risk on the credits diminishes.

The present invention thus eliminates the historical impediments to mixed-income projects, thereby creating, for the first time, an efficient marketplace for the syndication of credits.

### BRIEF DESCRIPTION OF THE DRAWINGS

FIG. 1 depicts a flow chart detailing one implementation of the computer software used to model the structure, according to an embodiment of the present invention.

FIG. 2 depicts potential project development inputs to the computer model, according to an embodiment of the present invention.

FIG. 3 depicts potential syndicator and investor assumption inputs to the computer model, according to an embodiment of the present invention.

FIG. 4 depicts structuring alternatives programmed into the model, according to an embodiment of the present invention.

FIG. 5 depicts potential subroutines used in the model programmed in Microsoft Excel, according to an embodiment of the present invention.

FIG. 6 depicts typical outputs produced by the computer model, according to an embodiment of the present invention.

FIG. 7 depicts a flow chart showing a general form of the implementation of the method of the invention, according to an embodiment of the present invention.

FIG. 8 depicts a single partnership structure with multiple building mixed-income projects, according to an embodiment of the present invention.

FIG. 9 depicts a 99-1 condominium single partnership structure for a single building mixed-income project, according to an embodiment of the present invention.

FIG. 10 depicts a two partnership structure with a SNDA, according to an embodiment of the present invention.

FIG. 11 depicts a two partnership structure with a guaranty, according to an embodiment of the present invention.

FIG. 12 depicts a two partnership structure with an escrow, according to an embodiment of the present invention.

### DETAILED DESCRIPTION OF THE PREFERRED EMBODIMENTS

The present invention relates to a method and provides for a more efficient structure for the development of new and existing mixed-income projects, as well as a more effective means of utilizing the associated credits, according to an embodiment of the invention.

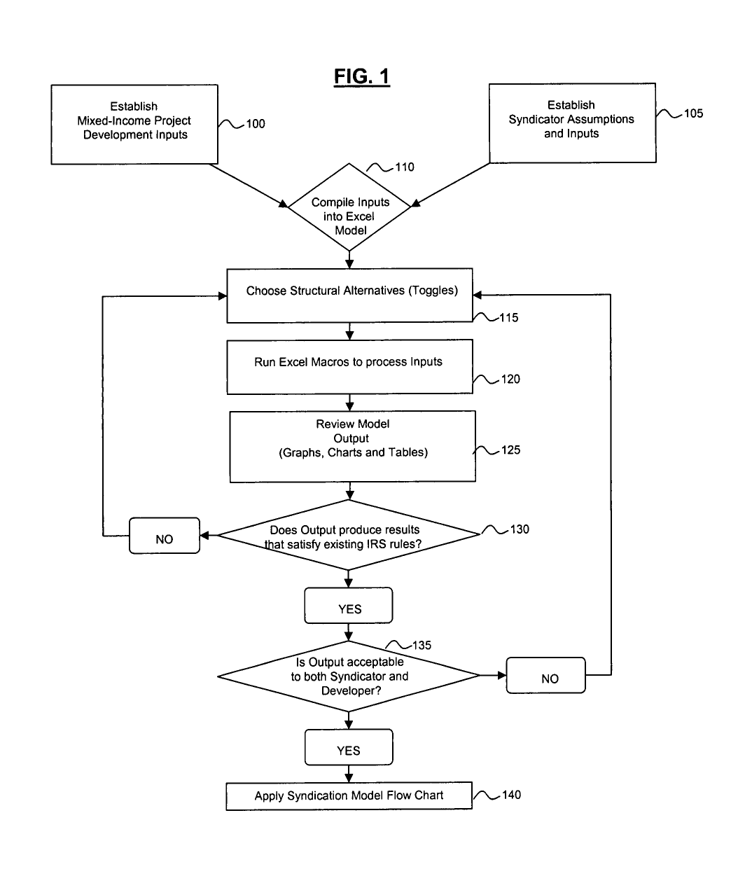

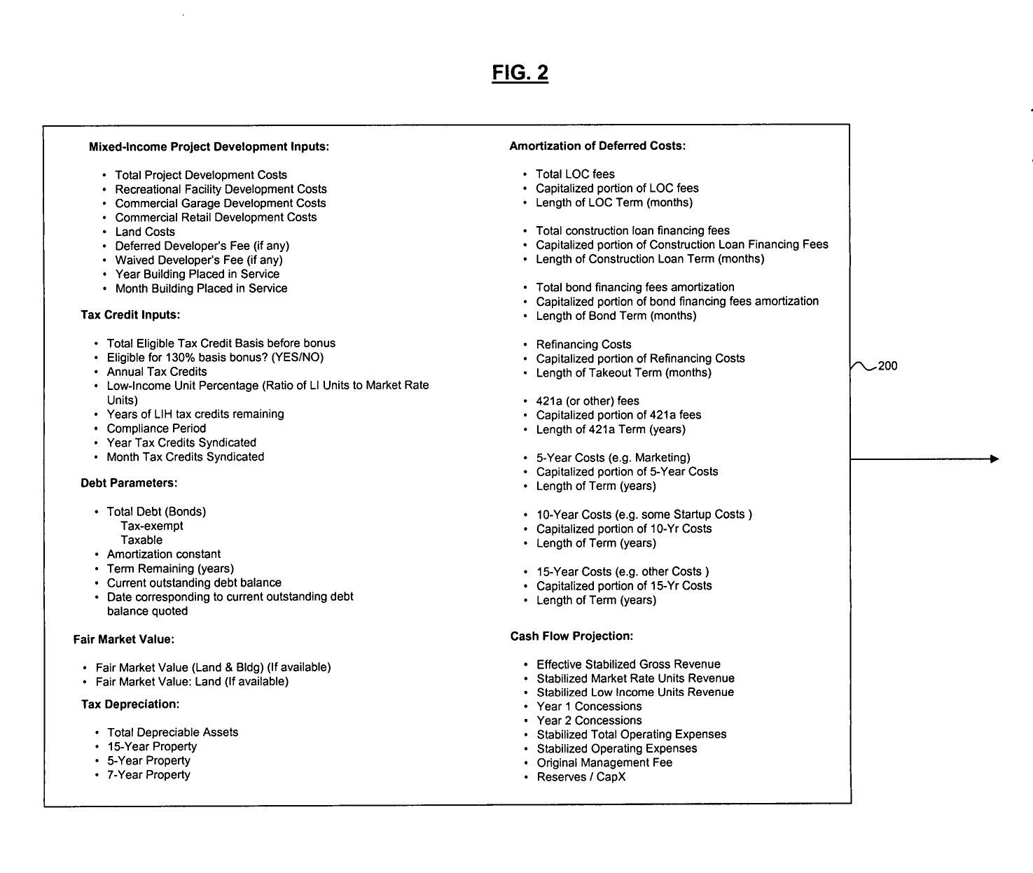

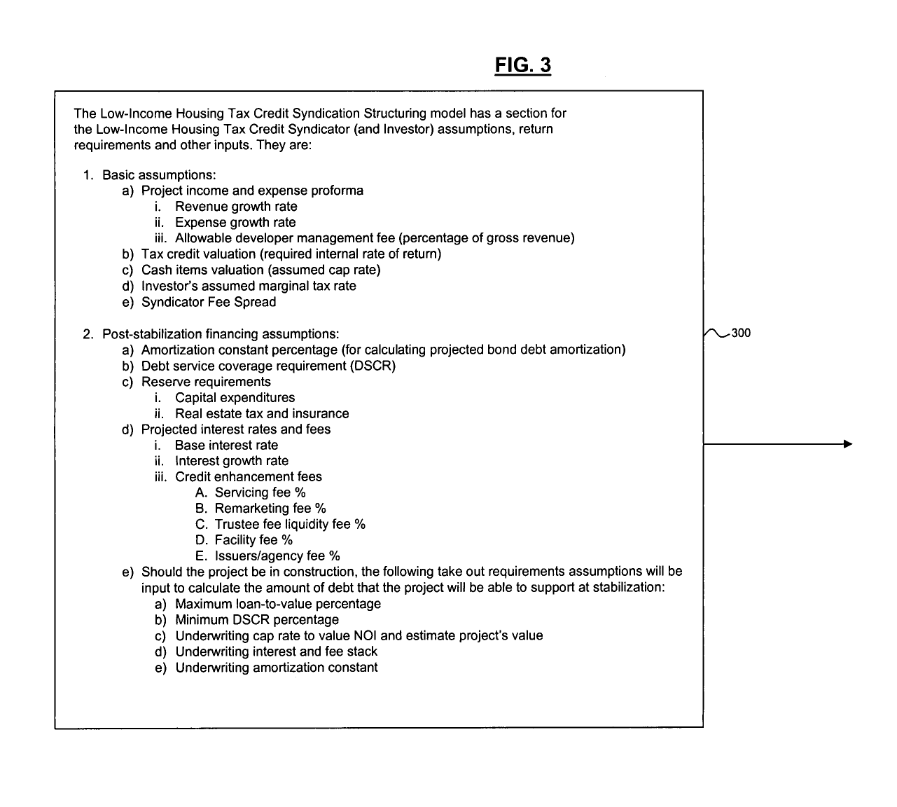

FIG. 1 is a flow chart that depicts a method of identifying syndication opportunity according to an embodiment of the present invention. Referring to FIG. 1, in step 100 and 105, a computer or a computer program, for example, collects and inputs variables associated with a given mixed-income project. In step 100, the inputs comprise project development inputs. In step 105, the inputs comprise assumptions regarding the credit syndicator and credit investor. These inputs generally relate to economic details of housing projects, for example, those shown in FIGS. 2 and 3 respectively. For example, the inputs in step 100 may include information regarding the total project development costs, credits, parameters of the debt, fair market value, tax depreciation, amortization of deferred costs, and cash flow projection, among others. The inputs referred to in FIG. 3 may include basic assumptions and post-stabilization financing assumptions, among others.

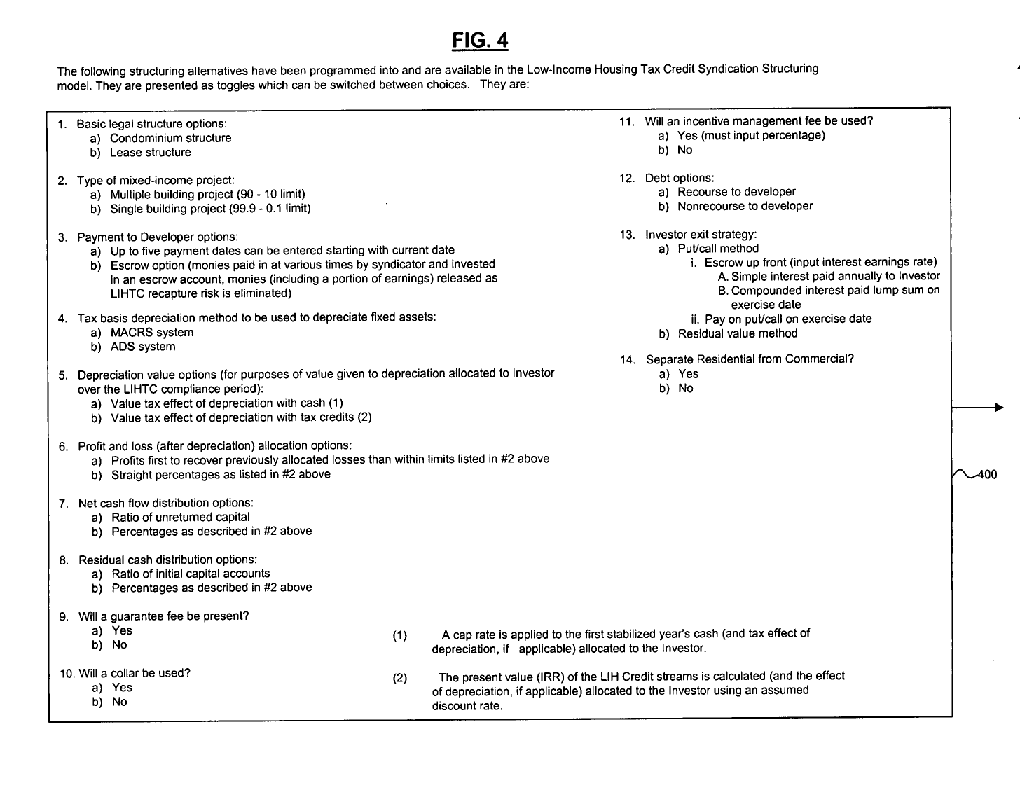

Once collected in steps 100 and 105, the inputs may be compiled into a computer software model, such as for example a spreadsheet program like Microsoft Excel. In step 115, the computer program or user chooses from among various structural alternatives. Each alternative determines the type of calculations performed upon the input data assumptions. The alternatives may be chosen in step 115 by the computer alone or by the user after presentation of the various alternatives, in any convenient manner. FIG. 4 details one embodiment, wherein these structuring alternatives are displayed as binary choices available to the user. For example, the basic legal structure may either be a condominium structure or a lease structure, and the type of mixed-income project may either be a multiple-building project or a single-building project. A user may choose between these by selecting one or the other.

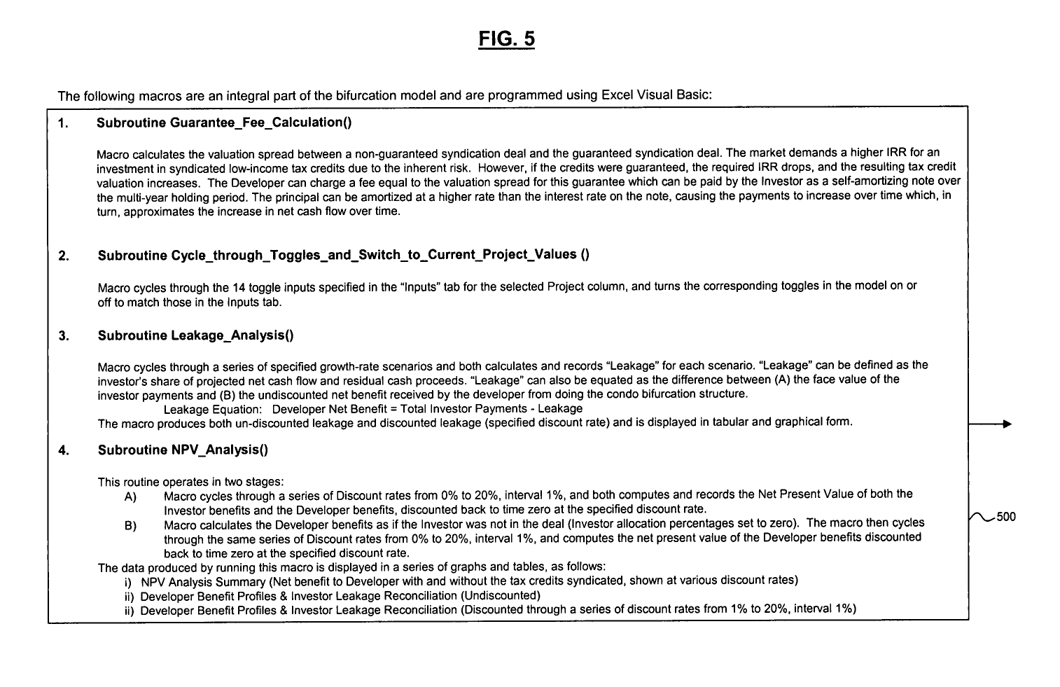

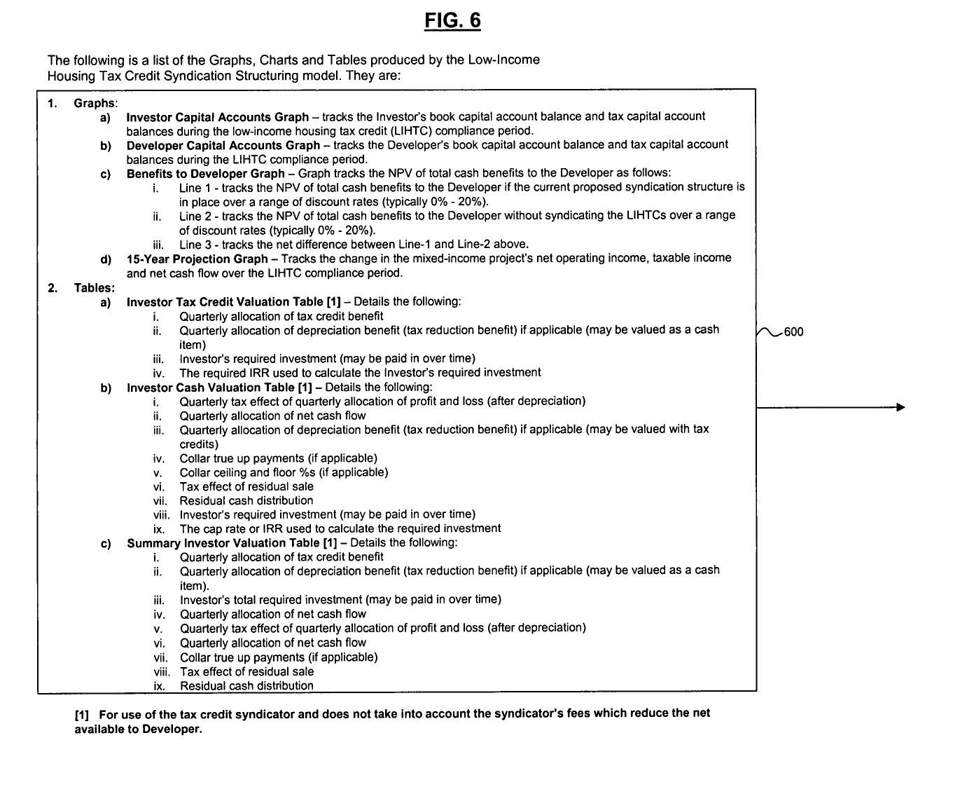

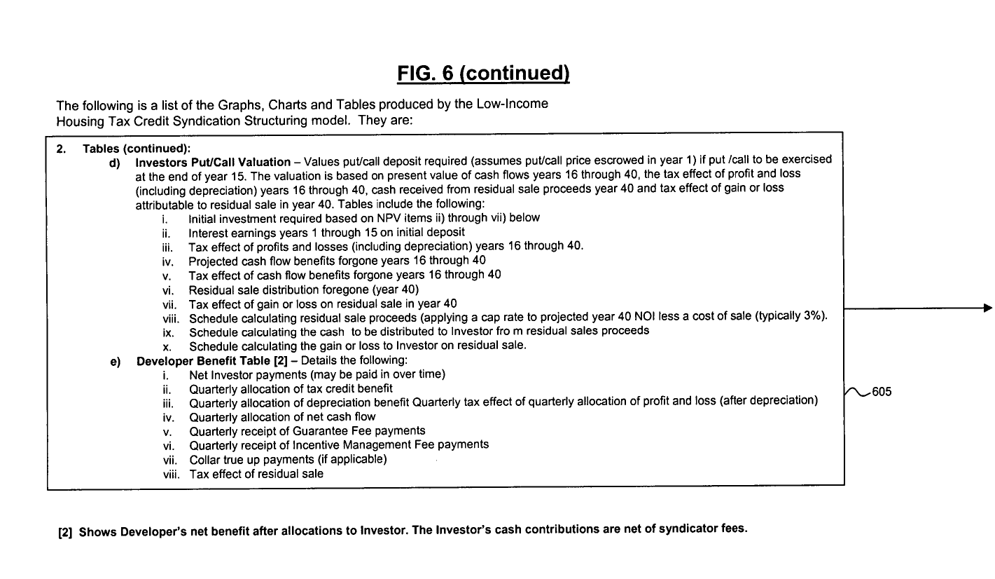

In step 120, the computer software program performs the calculations upon the inputs, according to the calculation model associated with the chosen structural alternatives. According to one embodiment, these calculations may be performed in a spreadsheet program, for example macros programmed in Microsoft Excel. Illustrative macros are shown in FIG. 5. Once the calculations have been performed, in step 125 the computer program outputs the data generated by the model in a human-readable format, for example as graphs, charts, and/or tables. Illustrative outputs in step 125 are shown in FIG. 6. Graphs may include those that track the investor capital accounts, the developer capital accounts, benefits to the developer, and a 15-year projection. Tables may include a credit investor credit tally, and cash valuation tables, and an investor valuation table with content pertaining to the economics associated with the outputs in step 125.

In step 130, the information outputted in step 125 is examined to verify that it satisfies existing IRS rules. If the answer is no, step 115 may begin again and the structural alternatives may be varied to produce different results. If the model output does comply with IRS rules, then the output is presented to both the syndicator and the developer for consideration in step 135. Again, if either the syndicator or the developer does not agree upon the terms generated by the computer program, the structural alternatives may be varied to produce different results. If the syndicator and developer do agree on the structure proposed by the model outputs, these are applied as the foundation for the syndication model in step 140.

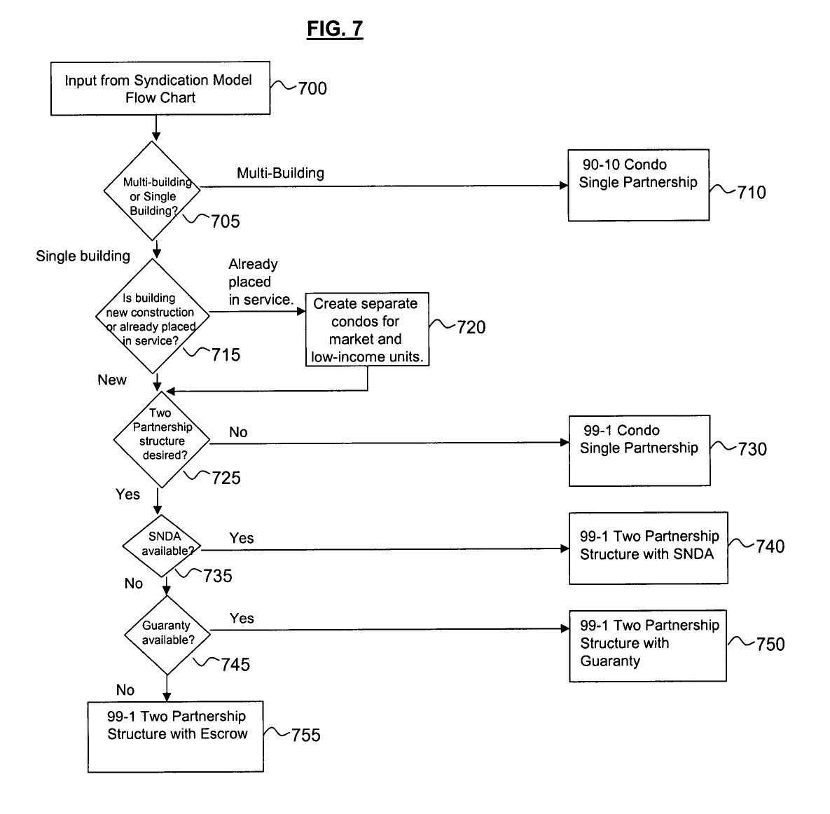

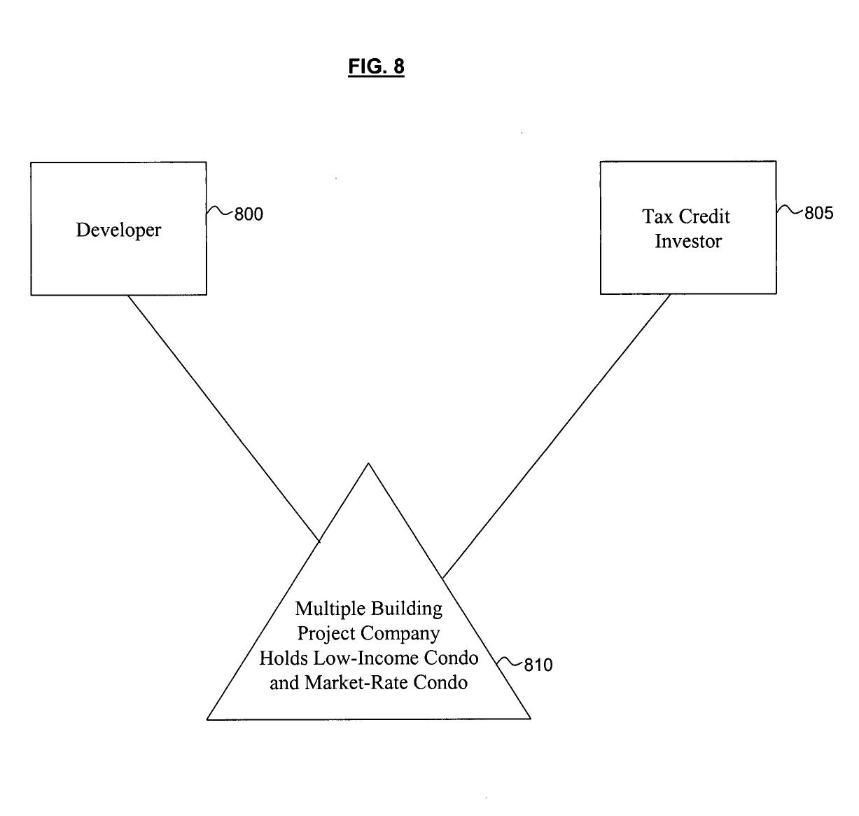

FIG. 7 depicts a decision tree representing a method of implementing the present invention. In general, all of the inputs, outputs, or structures chosen as a result of the method of FIG. 1 are available as inputs in step 700. In step 115, structural alternatives were chosen relating to the specific characteristics of the building development and tax structure of interest. In step 705, a development project is determined to be either a multi-building or a single-building development. If the structure of interest relates to a multi-building development, documents for a 90-10 condominium single partnership are generated and executed in step 710, as further detailed in FIG. 8.

FIG. 8 depicts a structure for holding project assets according to an embodiment of the present invention, reflected in documents generated and executed by specifying the entrance of the developer 800 and the credit investor 805 into a partnership 810 (the multiple-building project company) that holds both the physical low-income and market-rate condominiums. For example, the agreement may specify that the developer agrees to take less than 90% of depreciation deductions from the market-rate condominiums in the buildings and more than 10% of the depreciation deductions from the low-income condominiums in the buildings. Additionally, the developer agrees to take less than 90% of the operating income and capital gains, as well as less than 90% of the losses from both the market-rate and the low-income condominiums (after excluding specially allocated depreciation deductions. Lastly, the developer takes less than 90% of the cash flow from both the market-rate and the low-income condominiums.

The credit investor 805 agrees to take less than 90% of depreciation deductions from the low-income condominiums (and less than 90% of the resulting credits) in the buildings and more than 10% of the depreciation deductions from the market-rate condominiums in the buildings. Additionally, the credit investor agrees to take more than 10% of the operating income and capital gains, as well as more than 10% of the losses from both the market-rate and the low-income condominiums (after excluding specially allocated depreciation deductions). Lastly, the credit investor takes less than 90% of the cash flow from both the market-rate and the low-income condominiums.

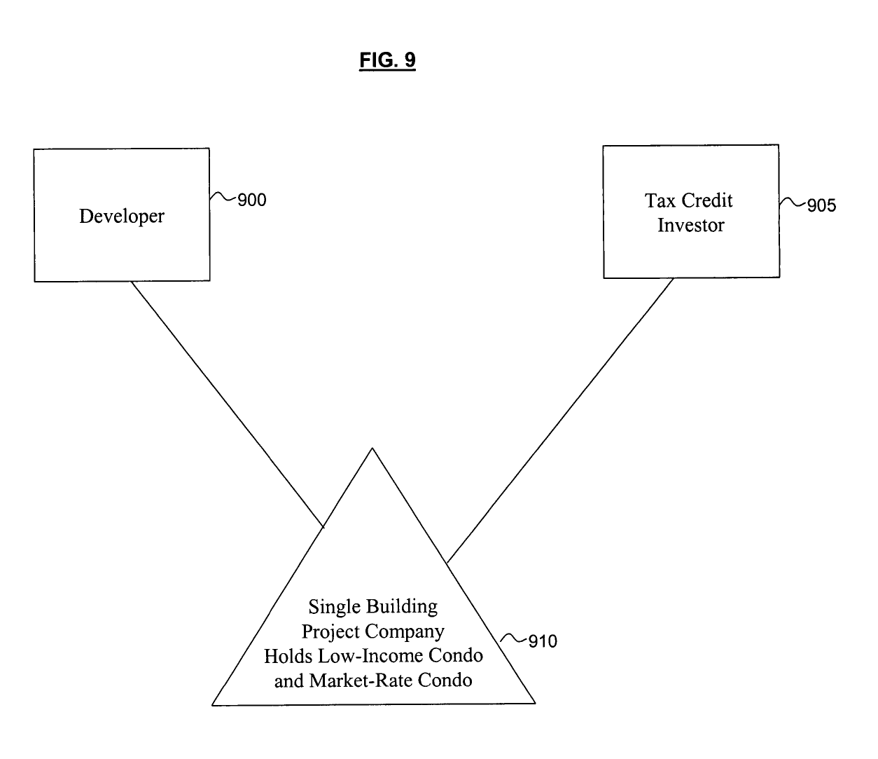

Referring back to FIG. 7, if the structure of interest relates to a single building, in step 715 the building is determined to be either a new construction or one already placed in service. If the building is already placed in service, then in step 720 the units within the building are separated into market-rate and low-income condos. If the building is new, then step 725 determines if a two-partnership structure is desired. If the answer is no, then a condominium single-partnership structure, such as a 99-1 single-partnership structure, is entered into in step 730, as detailed in FIG. 9.

FIG. 9 depicts a structure for holding project assets according to an embodiment of the present invention, reflected in documents generated and executed specifying the entrance of the developer 900 and the credit investor 905 into a partnership 910 (the single-building project company). Again, the project company holds both the low-income and the market-rate condominiums.

For example, the developer agrees to accept less than 99.9% of the depreciation deductions from the market-rate condominiums and more than 0.1% of the depreciation deductions from the low-income condominiums, as well as less than 99.9% of the operating income and capital gains from the market-rate condominiums. Additionally, the developer takes less than 90% of operating income and capital gains from the low-income condominiums. The developer accepts less than 99.9% of the losses from the entire building (after excluding specially allocated depreciation deductions). Lastly, the developer accepts less than 99.9% of the cash flow from the market-rate condominiums and less than 90% of the cash flow from the low-income condominiums.

The credit investor 905 agrees to accept less than 99.9% of the depreciation deductions from the low-income condominiums (and according less than 99.9% of the resulting credits), and more than 0.1% of the depreciation deductions from the market-rate condominiums, as well as more than 0.1% of the operating income and capital gains from the market-rate condominiums. Additionally, the credit investor takes more than 10% of operating income and capital gains from the low-income condominiums. The credit investor accepts more than 0.1% of the losses from the entire building (after excluding specially allocated depreciation deductions). Lastly, the credit investor accepts more than 0.1% of the cash flow from the market-rate condominiums and more than 10% of the cash flow from the low-income condominiums.

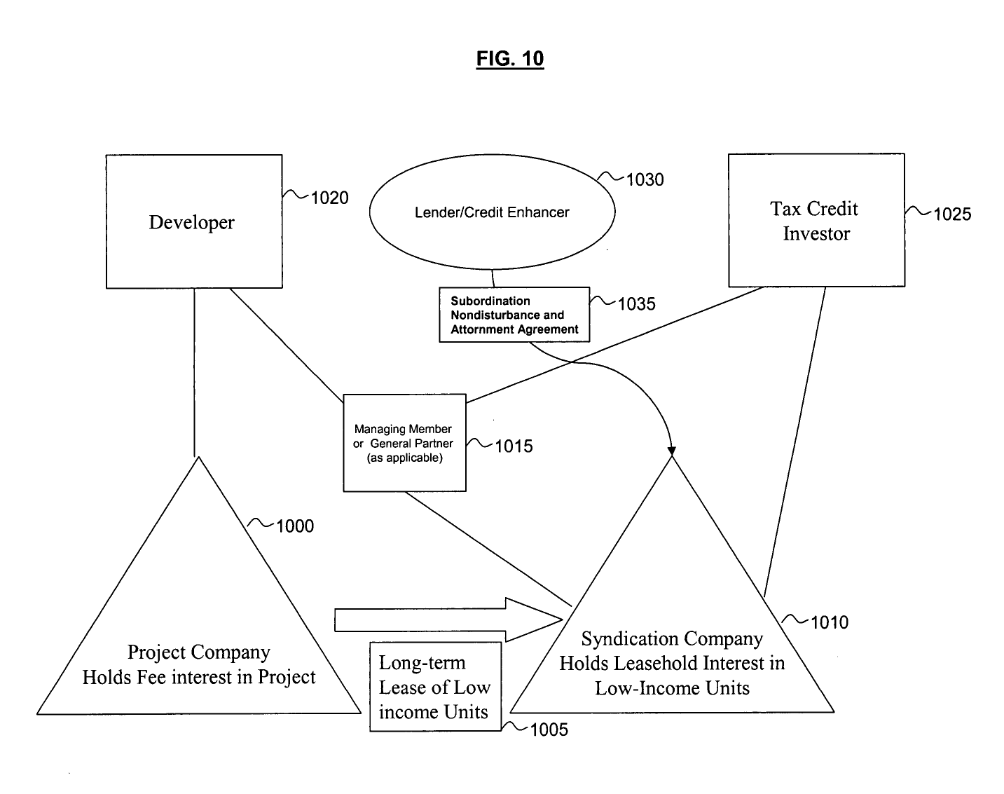

Referring back to FIG. 7, in step 725, if a two partnership structure is desired, then the availability of a Subordination, Nondisturbance and Attornment Agreement (“SNDA”) is determined in step 735. If an SNDA is available, then step 740 shows that a 99-1 two-partnership structure with an SNDA is formed, as detailed in FIG. 10.

FIG. 10 depicts a structure for holding project assets according to an embodiment of the present invention, reflected in documents generated and executed specifying the design of a two-partnership structure of the capital lease technique including an SNDA, for example a 99-1 two-partnership structure. In this example, the project company 1000 holds the fee interest in the project. The project company leases the low-income units 1005 to the syndication company 1010, with the lease being sufficiently long-term to be considered a sale. The syndication company 1010 then holds the leasehold interest in the low-income units. The developer 1020 and the tax credit investor 1025 again form a syndication company, this time interacting with the syndication company by way of a managing member or general partner 1015 as applicable.

The credit investor 1025 would contribute cash to the syndication company 1010 in exchange for membership interests entitling the credit investor up to a 99.9% share of the profits, losses, and depreciation deductions of the syndication company as well as up to 99.9% of the credits. Additionally, the credit investor would accept 0.1% or less of the capital gains. The general partner/managing member of the syndication company would retain up to a 99.9% interest in any capital gains resulting from the syndication company, with 0.1% or less of depreciation, credits, ordinary income, losses, and cash flow. Of the allocations to the managing member/general partner 1015, less than 80.0% would then be allocated to the developer, with more than 20.0% allocated to the tax credit investor.

Lastly, the syndication company obtains an SNDA 1035 from the lender/credit enhancer 1030 of the mortgage on the mixed-income project that would avoid any risk of recapture or termination of the credits even in the unlikely event of a foreclosure on the market-rate units. The credit enhancer, in exchange for a fee, agrees to enter into an SNDA with the syndication company, thereby subordinating the mortgage to the long-term lease and providing that in the event of a foreclosure, the credit enhancer will honor the syndication company's lease. The SNDA preserves the low-income nature of the syndication company and ensures that the credits will not be recaptured as long as the syndication company continues to make payments on the long-term lease. The credit enhancer may be permitted, pursuant to the terms of the SNDA, to replace the general partner of the syndication company in the event of a default on the mortgage.

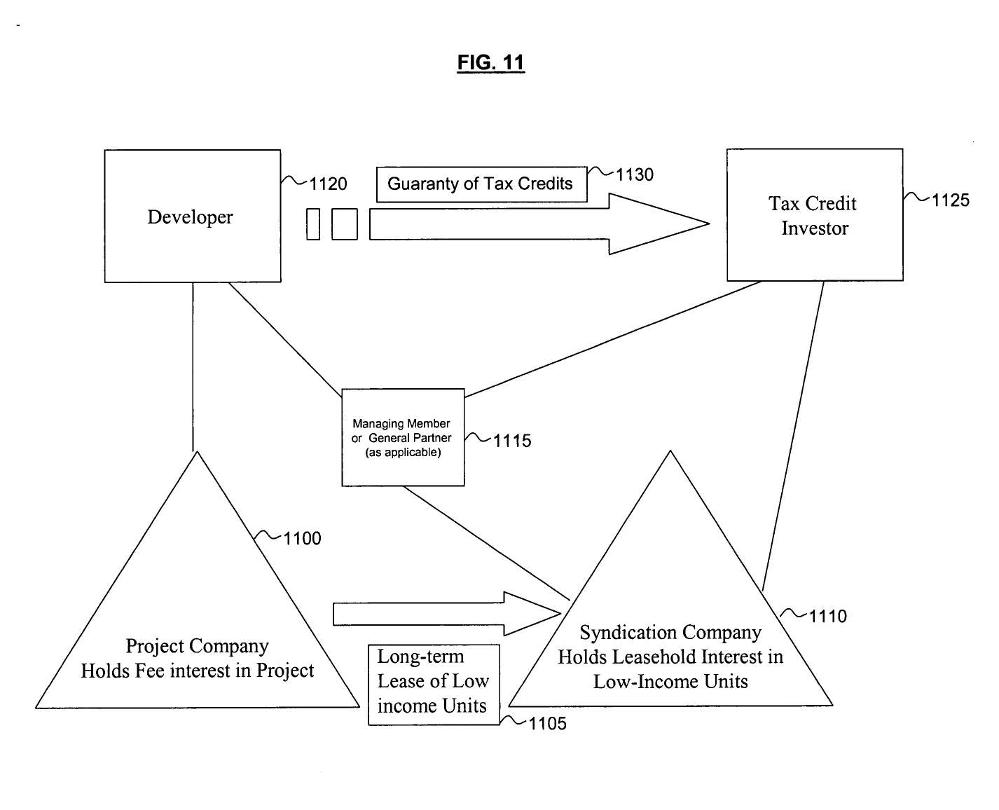

Referring back to FIG. 7, in step 735, if an SNDA is not available, then the availability of a guaranty is determined in step 745. If a guaranty is available, then step 750 shows that a 99-1 two-partnership structure with a guaranty is formed, as detailed in FIG. 11.

FIG. 11 depicts a structure for holding project assets according to an embodiment of the present invention, reflected in documents generated and executed specifying the design of a two-partnership structure, for example a 99-1 two-partnership structure, of the capital lease technique with a guaranty. In this example, the project company 1100 holds the fee interest in the project. The project company leases the low-income units 1105 to the syndication company 1110, with the lease being sufficiently long-term to be considered a sale. The syndication company 1110 then holds the leasehold interest in the low-income units. The developer 1120 and the tax credit investor 1125 again form a syndication company, this time interacting with the syndication company by way of a managing member or general partner 1115 as applicable.

The credit investor 1125 would contribute cash to the syndication company 1110 in exchange for membership interests entitling the credit investor up to a 99.9% share of the profits, losses, and depreciation deductions of the syndication company as well as up to 99.9% of the credits. Additionally, the credit investor would accept 0.1% or less of the capital gains. The general partner/managing member of the syndication company would retain up to a 99.9% interest in any capital gains resulting from the syndication company, with 0.1% or less of depreciation, credits, ordinary income, losses, and cash flow. Of the allocations to the managing member/general partner 1115, less than 80.0% would then be allocated to the developer, with more than 20.0% allocated to the tax credit investor. Lastly, the credit investor 1125 arranges financial guarantee from the project company that the credits will not be recaptured in the event of economic failure of the market-rate units and the ensuing foreclosure of the project.

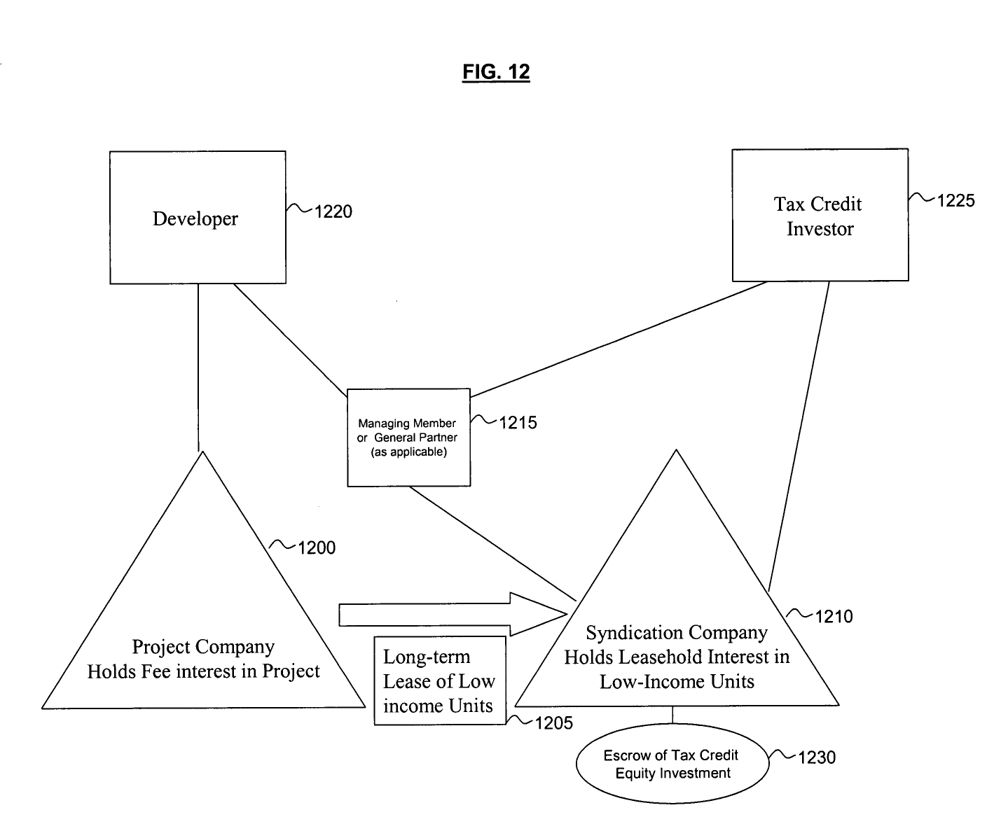

Referring back to FIG. 7, step 745, if a guaranty is not available, then a 99-1 two-partnership structure with an escrow is formed, as detailed in FIG. 12.

FIG. 12 depicts a structure for holding project assets according to an embodiment of the present invention, reflected in documents generated and executed specifying the design of a two-partnership structure, for example a 99-1 two-partnership structure, of the capital lease technique with an escrow. In this example, the project company 1200 holds the fee interest in the project. The project company leases the low-income units 1205 to the syndication company 1210, with the lease being sufficiently long-term to be considered a sale. The syndication company 1210 then holds the leasehold interest in the low-income units. The developer 1220 and the tax credit investor 1225 again form a syndication company, this time interacting with the syndication company by way of a managing member or general partner 1215 as applicable.

The credit investor 1225 would contribute cash to the syndication company 1210 in exchange for membership interests entitling the credit investor up to a 99.9% share of the profits, losses, and depreciation deductions of the syndication company as well as up to 99.9% of the credits. Additionally, the credit investor would accept 0.1% or less of the capital gains. The general partner/managing member of the syndication company would retain up to a 99.9% interest in any capital gains resulting from the syndication company, with 0.1% or less of depreciation, credits, ordinary income, losses, and cash flow. Of the allocations to the managing member/general partner 1215, less than 80.0% would then be allocated to the developer, with more than 20.0% allocated to the tax credit investor. Lastly, the investment in the syndication company 1210 by the credit investor 1225 is placed into an interest-bearing escrow 1230 to be paid out to the syndication company 1210 over a period of years.

It will be understood by those having ordinary skill in the art that the methods described herein may be carried out by a general purpose computer executing the program instructions of one or more computer programs. The general purpose computer, for example, may employ spreadsheet or other programs to perform analysis and to determine structures and amounts described herein. The computer may be attached to various peripherals, including a display, storage devices, network devices, input devices, such as a mouse and keyboard, and output devices including a printer. In a network configuration, the computer may interact with other computers to collect input and present output, such as agreements or alternatives, to users to facilitate the methods described herein. In addition, one or more of the computers may be used to generate definitive agreements based on data accumulated during the performance of the method described herein.

While particular embodiments of the present invention have been shown and described, it will be understood by those having ordinary skill in the art that changes may be made to those embodiments without departing from the spirit and scope of the present invention.

What is claimed is:

1. A method of assessing and effecting the transfer of federal low-income housing tax credits generated by mixed-income housing tax credit projects to a qualified recipient, comprising the steps:
identifying a mixed-income housing project with tax credits available for syndication;
determining a partnership structure including at least one partnership for effecting the syndication of the tax credits;
documenting at least one enforceable agreement transferring value from a credit investor to a partnership in exchange for at least a portion of the tax credits;
documenting at least one enforceable partnership agreement establishing the determined partnership structure, and, in the case of a two-partnership structure to transfer for tax purposes the ownership of the low-income units in the project to the partnerships in which the credit investor is a partner; and
at least partly carrying out said agreements.

2. The method of claim 1, wherein one of the at least one partnership is a syndication entity, and at least one of the agreements documents an exchange of at least a portion of the value and ownership for tax purposes of the low-income units to the syndication entity.

3. The method of claim 1, wherein one of the at least one partnership is a project entity, and at least one of the agreements documents a transfer of at least a portion of the tax credits and ownership of the low-income units for tax purposes to a second partnership.

4. The method of claim 1, further comprising receiving project inputs; and
calculating the effects of the value-based economic factors.

5. The method of claim 4, wherein the economic factors include cash flow, profits, capital gains, and depreciation of the project.

6. The method of claim 4, wherein the calculations are used to optimize the agreements, including maximizing available syndicatable tax credits.

7. The method of claim 4, wherein the calculations are performed by a computer program.

8. The method of claim 1, further comprising documenting at least one enforceable agreement mitigating the risk of recapture or termination of the tax credits.

9. The method of claim 8, wherein the agreement mitigating the risk of recapture or termination of the tax credits is a Subordination, Nondisturbance and Attornment Agreement obtained from the lender or credit enhancer of the project.

10. The method of claim 8, wherein the agreement mitigating the risk of recapture or termination of the tax credits is a financial guaranty that the tax credits will not be recaptured.

11. The method of claim 8, wherein the agreement mitigating the risk of recapture or termination of the tax credits documents the placement of the value transferred from the credit investor into an interest-bearing escrow to be paid out to the syndication entity over a period of time.

12. The method of claim 11, wherein the period of time over which the escrow is paid out is a period of up to 15 years.

13. The method of claim 8, wherein a Subordination, Nondisturbance and Attornment Agreement is preferably obtained, and wherein a financial guaranty is obtained if a Subordination, Nondisturbance and Attornment Agreement is not available, and wherein the credit investor's investment is placed into an escrow if a financial guaranty is not available.

14. The method of claim 4, further comprising documenting at least one enforceable agreement mitigating the risk of recapture or termination of the tax credits, and wherein the enforceable agreement includes a cost determined by the economic factors.

15. The method of claim 14, wherein the cost is calculated by a computer program.

16. The method of claim 14, wherein the agreement mitigating the risk of recapture or termination of the tax credits is a Subordination, Nondisturbance and Attornment Agreement obtained from the lender or credit enhancer of the project.

17. The method of claim 14, wherein the agreement mitigating the risk of recapture or termination of the tax credits is a financial guaranty that the tax credits will not be recaptured.

18. The method of claim 14, wherein the agreement mitigating the risk of recapture or termination of the tax credits documents the placement of the value transferred from the credit investor into an interest-bearing escrow to be paid out to the syndication entity over a period of time.

19. The method of claim 18, wherein the period of time over which the escrow is paid out is a period of up to 15 years.

20. The method of claim 14, wherein a Subordination, Nondisturbance and Attornment Agreement is preferably obtained, and wherein a financial guaranty is obtained if a Subordination, Nondisturbance and Attornment Agreement is not available, and wherein the credit investor's investment is placed into an escrow if a financial guaranty is not available.

21. A method of assessing and effecting the transfer of federal low-income housing tax credits generated by mixed-income housing tax credit projects to a qualified recipient, comprising the steps:
identifying a mixed-income housing project with tax credits available for syndication;
identifying value-based economic factors that affect the syndicatability of the tax credits;
modeling the effects of the value-based economic factors upon the syndication of the tax credits;
determining a partnership structure including at least one partnership for effecting the syndication of the tax credits in terms of the modeled economic factors;
documenting at least one enforceable partnership agreements establishing the determined partnership structure;
documenting at least one enforceable agreement transferring at least a portion of value from a credit investor to a partnership in exchange for at least a portion of the tax credits;
documenting at least one enforceable partnership agreement establishing the determined partnership structure, and, in the case of a two-partnership structure to transfer for tax purposes the ownership of the low-income units in the project to the partnerships in which the credit investor is a partner; and
at least partly carrying out said agreements.

22. The method of claim 21, wherein one of the at least one partnership is a syndication entity, and at least one of the agreements documents an exchange of at least a portion of the value and ownership for tax purposes of the low-income units to the syndication entity.

23. The method of claim 21, wherein one of the at least one partnership is a project entity, and at least one of the agreements documents a transfer of at least a portion of the tax credits and ownership of the low-income units for tax purposes to a second partnership.

24. The method of claim 21, further comprising receiving project inputs; and
calculating the effects of the value-based economic factors.

25. The method of claim 24, wherein the economic factors include cash flow, profits, capital gains, and depreciation of the project.

26. The method of claim 24, wherein the calculations are used to optimize the partnership structuring agreements including maximizing available syndicatable tax credits.

27. The method of claim 24, wherein the calculations are performed by a computer program.

28. The method of claim 21, further comprising documenting at least one enforceable agreement mitigating the risk of recapture or termination of the tax credits.

29. The method of claim 28, wherein the agreement mitigating the risk of recapture or termination of the tax credits is a Subordination, Nondisturbance and Attornment Agreement obtained from the lender or credit enhancer of the project.

30. The method of claim 28, wherein the agreement mitigating the risk of recapture or termination of the tax credits is a financial guaranty that the tax credits will not be recaptured.

31. The method of claim 28, wherein the agreement mitigating the risk of recapture or termination of the tax credits documents the placement of the value transferred from the credit investor into an interest-bearing escrow to be paid out to the syndication entity over a period of time.

32. The method of claim 31, wherein the period of time over which the escrow is paid out is a period of up to 15 years.

33. The method of claim 28, wherein a Subordination, Nondisturbance and Attornment Agreement is preferably obtained, and wherein a financial guaranty is obtained if a Subordination, Nondisturbance and Attornment Agreement is not available, and wherein the credit investor's investment is placed into an escrow if a financial guaranty is not available.

34. The method of claim 24, further comprising documenting at least one enforceable agreement mitigating the risk of recapture or termination of the tax credits, and wherein the enforceable agreement includes a cost determined by the economic factors.

35. The method of claim 34, wherein the cost is calculated by a computer program.

36. The method of claim 34, wherein the agreement mitigating the risk of recapture or termination of the tax credits is a Subordination, Nondisturbance and Attornment Agreement obtained from the lender or credit enhancer of the project.

37. The method of claim 34, wherein the agreement mitigating the risk of recapture or termination of the tax credits is a financial guaranty that the tax credits will not be recaptured.

38. The method of claim 34, wherein the agreement mitigating the risk of recapture or termination of the tax credits documents the placement of the value transferred from the credit investor into an interest-bearing escrow to be paid out to the syndication entity over a period of time.

39. The method of claim 38, wherein the period of time over which the escrow is paid out is a period of up to 15 years.

40. The method of claim 34, wherein a Subordination, Nondisturbance and Attornment Agreement is preferably obtained, and wherein a financial guaranty is obtained if a Subordination, Nondisturbance and Attornment Agreement is not available, and wherein the credit investor's investment is placed into an escrow if a financial guaranty is not available.

41. A computer software program having computer program logic therein that causes a computer to:
receive input associated with the transfer of federal low-income housing tax credits generated mixed-income housing tax credit project; and
determine output related to economic factors that affect at least one of the syndicatability of the tax credits, the structure of partnerships involved in the syndication of the tax credits, and the form of documents and agreements.

42. The method of claim 41, wherein the value-based economic factors include cash flow, profits, capital gains, and depreciation of the project.

43. The method of claim 41, wherein the calculations may be used to optimize the partnership structuring agreement, including maximizing available syndicatable tax credits.

44. The computer software program of claim 41, wherein the inputs comprise variables relating to at least one of the project and the syndication of the tax credits.

45. The computer software program of claim 41, wherein the variables comprise development information, tax credit information, debt parameters, fair market value information, tax depreciation information, information relating to the amortization of deferred costs, and cash flow projection.

46. The computer software program of claim 41, further comprising computer program logic therein that causes a computer to allows a user to provide input regarding desired partnership structure.

47. The computer software program of claim 41, further comprising computer program logic therein that causes a computer to output models.

48. The computer software program of claim 47, wherein the models comprise at least one of graphs, charts, and tables.

49. The computer software program of claim 48, wherein the model conveys information about investor capital accounts, developer capital accounts, benefits to developers, 15-year projections of the net operating income, taxable income, and net cash flow, investor tax credit valuation, investor cash valuation, and summaries of investor valuation.

50. A method of assessing the transfer of federal low-income housing tax credits generated by mixed-income housing tax credit projects to a qualified recipient, comprising the steps:
determining value-based economic and predetermined structural factors that effect the syndicatability of the tax credits; and
determining a desired partnership structure including at least one partnership for effecting the syndication of the tax credits based upon the economic and structural factors, as well as assumptions related to members involved in the partnerships.

51. The method of claim 50, wherein the method determines that the project is not feasible.

52. The method of claim 50, wherein the method determines that the project is feasible.

53. The method of claim 52, further comprising determining economic projections resulting from the economic factors and the desired partnership structures.

54. The method of claim 53, wherein the value-based economic factors include cash flow, profits, capital gains, and depreciation of the project.

55. The method of claim 50, wherein the predetermined structural factors comprise:
a multi- or single-building status of the project; and
an in-service status of the project.

56. The method of claim 50, wherein the determination of the desired partnership structure includes choosing from among predetermined structural alternatives.

57. The method of claim 56, wherein the predetermined structural factors comprise:
desirability of a two-partnership structure; and
the availability of a technique for mitigating the risk of recapture or termination of the tax credits.

58. The method of claim 57, wherein the technique for mitigating the risk of recapture or termination of the tax credits is a Subordination, Nondisturbance and Attornment Agreement from the lender or credit enhancer of the project.

59. The method of claim 57, wherein the technique for mitigating the risk of recapture or termination of the tax credits is a financial guaranty that the tax credits will not be recaptured.

60. The method of claim 56, wherein the predetermined structural alternatives include:
basic legal structure, type of project, method of payment, tax basis depreciation method, depreciation value, profit and loss allocation, net cash flow distribution, residual cash distribution, presence of a guarantee fee, presence of a collar, presence of an incentive management fee, debt allocation, investor exit strategy, and separation of residential from commercial.

61. The method of claim 50, wherein the value-based economic factors are determined based on information related to:
project development, tax credits, debt parameters, fair market value, tax depreciation, amortization of deferred costs, and cash flow projection.

62. The method of claim 50 wherein the assumptions are related to a syndicator and a credit investor.

63. The method of claim 52, further comprising generating models.

64. The method of claim 63, wherein the generated models are based upon the value-based economic factors, the predetermined structural factors, and the desired partnership structure.

65. The method of claim 63, wherein the models comprise at least one of:
charts, tables, and graphs.
